(19) United States
(12) Patent Application Publication
(10) Pub. No.: US 2013/0234990 A1
(43) Pub. Date: Sep. 12, 2013

(54) INTERACTIVE INPUT SYSTEM AND METHOD

(71) Applicants: YUNQIU (RACHEL) WANG, Calgary (CA); NICHOLAS SVENSSON, Calgary (CA); NEIL BULLOCK, Calgary (CA); GRANT MCGIBNEY, Calgary (CA)

(72) Inventors: YUNQIU (RACHEL) WANG, Calgary (CA); NICHOLAS SVENSSON, Calgary (CA); NEIL BULLOCK, Calgary (CA); GRANT MCGIBNEY, Calgary (CA)

(73) Assignee: SMART Technologies ULC, Calgary (CA)

(21) Appl. No.: 13/413,510

(22) Filed: Mar. 6, 2012

(51) Int. Cl. G06F 3/042

(52) U.S. Cl. 345/175

(57) ABSTRACT

An interactive input system comprising: a pair of transparent panels separated in a parallel-spaced relationship defining a passage therebetween; a radiation structure directing radiation towards the pair of transparent panels, a first portion of the radiation redirected towards the passage in response to at least one pointer brought into proximity with a surface of one of the transparent panels, and a second portion of the first portion of radiation reflected by the other of the transparent panels back towards the passage; at least two imaging devices positioned adjacent to the pair of transparent panels, each of the at least two imaging devices having a field of view looking into the passage and capturing image frames thereof, the at least two imaging devices capturing the image frames from different vantages; and processing structure for processing the image frames to determine a location of the at least one pointer.

### FIELD OF THE INVENTION

The present invention relates to input systems and in particular to an interactive input system and method.

### BACKGROUND OF THE INVENTION

Interactive input systems that allow users to inject input (e.g., digital ink, mouse events, etc.) into an application program using an active pointer (e.g., a pointer that emits light, sound or other signal), a passive pointer (e.g., a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the entire contents of which are herein incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison, et al., discloses a touch system that employs machine vision to detect pointer interaction with a touch surface on which a computer-generated image is presented. A rectangular bezel or frame surrounds the touch surface and supports imaging devices in the form of digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of radiation traveling through an optical waveguide is frustrated when an object such as a pointer touches the waveguide surface, due to a change in the index of refraction of the waveguide, causing some radiation to escape from the touch point. In a multi-touch interactive input system, the machine vision system captures images including the point(s) of escaped radiation, and processes the images to identify the position of the pointers on the waveguide surface based on the point(s) of escaped radiation for use as input to application programs.

One example of interactive input system based on FTIR is disclosed in United States Patent Application Publication No. 2008/0179507 to Han. Han discloses a multi-touch sensing display system employing an optical waveguide, a light source, a light absorbing surface and an imaging sensor, such as a camera. Light emitted from light source undergoes total internal reflection within optical waveguide. When an object, such as a finger F, is placed in contact with a contact surface of the optical waveguide, total internal reflection is frustrated thus causing some light to scatter from the optical waveguide. The contact will be detected by the imaging sensor. Moreover, a diffuser layer is further disposed on the rear side of the waveguide for displaying images projected by a projector arranged alongside the imaging sensor.

United States Patent Application Publication No. 2008/00284925 to Han discloses an optical waveguide in the form of a clear acrylic sheet, directly against a side of which multiple high-power infrared light emitting diodes (LEDs) are placed. The infrared light emitted by the LEDs into the acrylic sheet is trapped between the upper or lower surfaces of the acrylic sheet due to total internal reflection. A diffuser display surface or a LCD panel is disposed alongside the non-contact side of the acrylic sheet with a small gap between the two in order to keep the diffuser from frustrating the total internal reflection. Imaging sensors mounted orthogonally relative to the waveguide or on the side of an optical wedge beneath the waveguide detects the light escaped from the waveguide. Multi-touch detections are achieved.

United States Patent Application Publication No. 2009/0027357 to Morrison discloses a system of detecting contact on a display employing FTIR. The system includes a planar waveguide associated with a display and includes at least one edge facet and opposing surfaces. The system also includes one or more light emitting diodes such as LEDs coupled to the at least one edge facet for transmitting an optical signal into the waveguide such that the transmitted optical signal is totally internally reflected between the at least one edge facet and opposing surfaces. At least one optical sensing device, such as a camera, positioned substantially to face at least a portion of the edge facet, has a field of view of the entire top surface of the waveguide. Images shown on the top surface of the waveguide are analyzed to determine the location of contact on the display.

United States Patent Application Publication No. 2009/0122020 to Eliasson, et al., discloses a touch pad system including a radiation transmissive element. The transmissive element includes a first surface being adapted to be engaged by an object so as to reflect/scatter/emit radiation into the element, and a second surface opposite to the first surface. A detecting means is provided on either surface of the transmissive element. A modulation means is provided and adapted to prevent at least part of the reflected/scattered/emitted radiation by the object such that radiation from an object is detected by the detecting means after special modulation of the modulation means. Positions of contact on the surface of the transmissive element can be determined.

U.S. patent application Ser. No. 13/075,508 to Popovich, et al., discloses an interactive input system comprising an optical waveguide, a radiation source and at least one imaging device. The radiation source directs radiation into the optical waveguide and the radiation undergoes total internal reflection within the optical waveguide in response to at least one touch input on a surface of the optical waveguide. The imaging device positioned adjacent to the waveguide has a field of view looking inside the optical waveguide, and captures image frames thereof. Processing structure processes the image frames captured by the imaging device to determine a location of the at least one touch input based on a frequency of reflections of the radiation appearing in the image frame.

United States Patent Application Publication No. 2010/0315381 to Yi, et al., discloses a multi-touch sensing apparatus. The multi-touch sensing apparatus includes a display panel to display an image, a sensing light source to emit light to sense a touch image which is generated by an object and displayed on a back side of the display panel, and a camera to divide and sense the touch image. The camera is arranged in an edge of a lower side of the multi-touch sensing apparatus, or a mirror to reflect the touch image may be included in the multi-touch sensing apparatus.

United States Patent Application Publication No. 2011/0043490 to Powell, et al., discloses an integrated vision and display system comprising a display-image forming layer to transmit a display image for viewing through a display surface, a vision-system emitter, a visible- and infrared-transmissive light guide, and an imaging detector. The vision-system emitter emits the infrared light for illumination of objects on or near the display surface. The visible- and infrared-transmissive light guide is configured to receive the infrared light from the vision-system emitter, and to project the infrared light onto the objects outside of the narrow range of angles relative to the display surface normal. The imaging detector is configured to image infrared light of a narrow range of angles relative to the display surface normal.

Although there are various configurations for an interactive input system to detect touch contact using FTIR technology, most of systems have detecting means such as a camera looking at the back surface of the touch screen, and they require a projector to project images. As a result, such systems are typically very large, are heavy, and are not considered portable.

It is therefore an object of at least one aspect of the present invention to provide a novel interactive input system.

### SUMMARY OF THE INVENTION

Accordingly, in one aspect there is provided an interactive input system comprising a pair of transparent panels separated in a parallel-spaced relationship defining a passage therebetween, a radiation structure directing radiation towards the pair of transparent panels, a first portion of the radiation redirected towards the passage in response to at least one pointer brought into proximity with a surface of the one of the transparent panels, and a second portion of the first portion of radiation reflected by the other of the transparent panels back towards the passage, at least two imaging devices positioned adjacent to the pair of transparent panels, each having a field of view looking into the passage and capturing image frames thereof, the at least two imaging devices capturing the image frames from different vantages, and processing structure for processing the image frames to determine a location of the at least one pointer.

According to another aspect there is provided a method comprising providing a pair of parallel-spaced transparent panels having a passage defined therebetween, capturing image frames of at least one pointer brought into proximity with a first surface of one of the transparent panels, the at least one pointer causing radiation to be directed towards the passage from the first surface, at least a portion of the directed radiation reflected by the other of the transparent panels back towards the passage, and processing the image frames to determine a location of the at least one pointer.

### BRIEF DESCRIPTION OF THE DRAWINGS

Embodiments will now be described more fully with reference to the accompanying drawings in which:

FIG. 1 is a schematic view of an interactive input system according to an embodiment.

FIG. 2 is a cross-sectional view of the interactive input system of FIG. 1 taken along line A-A.

FIG. 3 is a block diagram of an imaging device for the interactive input system of FIG. 1.

FIG. 4 is a block diagram of a master controller for the interactive input system of FIG. 1.

FIG. 5a shows an exemplary image frame captured by one of the imaging devices of FIG. 1 in the event a pointer contacts the touch surface.

FIG. 5b is a processed image of FIG. 5a after ambient light is removed.

FIG. 6 is a schematic diagram of the image frame of FIG. 5b.

FIG. 7 is a flowchart of a method for processing captured image frames to determine the contact status and location of a pointer.

FIG. 8 is a flowchart of a calibration method for calculating the height of the passage.

FIG. 9a shows an exemplary background image frame.

FIG. 9b shows an exemplary image frame in the event a pointer is in contact with the touch surface.

FIG. 9c shows a difference image frame obtained from subtracting FIG. 9a from FIG. 9b.

FIG. 9d shows the vertical intensity profile (VIP) of FIG. 9c.

FIG. 10a shows an exemplary background image frame.

FIG. 10b shows an exemplary image frame in the event a pointer is in contact with the touch surface.

FIG. 10c shows a difference image frame obtained from subtracting FIG. 10a from FIG. 10b.

FIG. 10d shows the vertical intensity profile (VIP) of FIG. 10c.

FIG. 11a shows an exemplary background image frame.

FIG. 11b shows an exemplary image frame in the event a pointer is in contact with the touch surface.

FIG. 11c shows a difference image frame obtained from subtracting FIG. 11a from FIG. 11b.

FIG. 11d shows the vertical intensity profile (VIP) of FIG. 11c.

FIG. 12 is a flowchart of a method for processing captured image frames to determine the contact status and location of a pointer according to another embodiment.

FIGS. 13a and 13b show exemplary image frames in the event a finger is brought into proximity with the touch surface.

FIGS. 14a and 14b show exemplary image frames in the event a passive pointer is brought into proximity with the touch surface.

FIGS. 15a and 15b show exemplary image frames in the event an active pointer is brought into proximity with the touch surface.

FIG. 16 is a schematic diagram of an exemplary image frame.

FIG. 17 is a cross-sectional view of another embodiment of an interactive input system.

FIG. 18 is a bottom view showing the radiation structure forming part of the interactive input system of FIG. 17.

FIGS. 19a and 19b show alternative embodiments for the radiation structure forming part of the interactive input system of FIG. 17.

FIG. 20 is a cross-sectional view of another embodiment of an interactive input system.

FIG. 21 is a cross-sectional view of another embodiment of an interactive input system.

FIG. 22 is a cross-sectional view of another embodiment of an interactive input system.

FIG. 23 is a cross-sectional view of another embodiment of an interactive input system.

FIG. 24 is a schematic view of an interactive input system according to another embodiment.

FIG. 25 is a schematic view of an interactive input system according to another embodiment.

FIG. 26 is a schematic view of an interactive input system according to yet another embodiment.

### DETAILED DESCRIPTION OF THE EMBODIMENTS

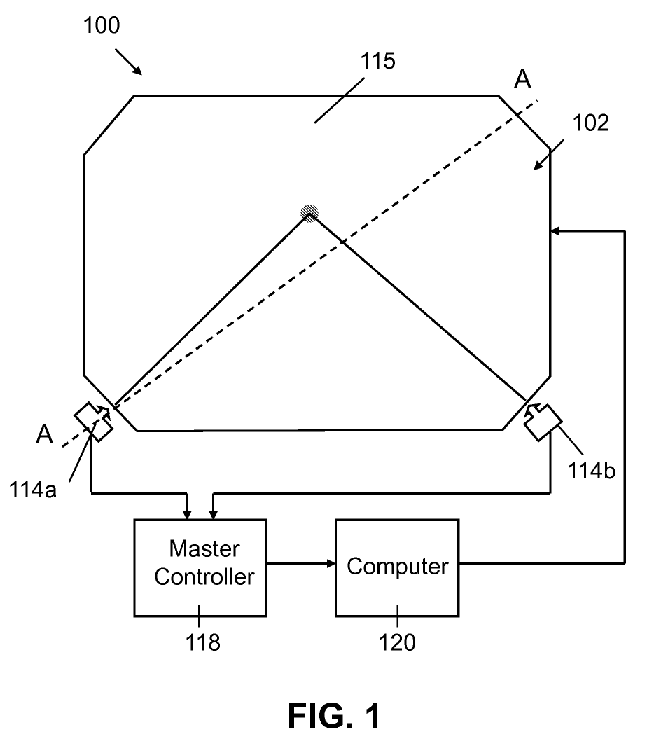

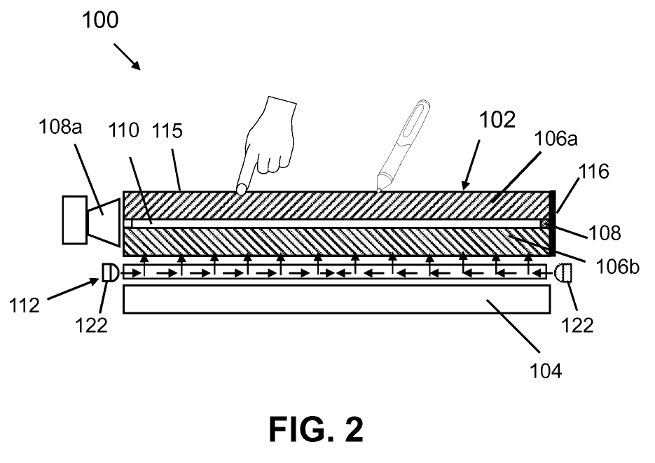

Turning now to FIGS. 1 and 2, an interactive input system is shown and is generally identified by reference numeral 100. In this embodiment, interactive input system 100 comprises a touch panel 102 sized and configured to be mounted atop or against a display unit 104, such as for example a liquid crystal display (LCD) device or a plasma television. The touch panel 102 comprises first and second transparent panels 106a and 106b. In this embodiment, the first and second transparent panels 106a and 106b are sheets of glass. The sheets of glass are generally rectangular in shape, and each have top and bottom planar surfaces. The first and second transparent panels 106a and 106b are arranged in a parallel-spaced relationship defining a passage 110 between the bottom planar surface of the first transparent panel 106a and the top planar surface of the second transparent panel 106b. In this embodiment, each of these surfaces abut against a respective side of a spacer 108.

Two (2) imaging devices 114a and 114b are positioned at respective corners of the touch panel 102. The touch panel 102 is configured to accommodate the imaging devices 114a and 114b by cutting off the corners of the first and second transparent panels 106a and 106b, as shown in FIG. 1. The imaging devices 114a and 114b have respective fields of view looking generally into the passage 110 and a portion of each of the first and second transparent panels 106a and 106b. A radiation structure 112 is positioned between the touch panel 102 and the display unit 104 and directs radiation towards the touch panel 102. In this embodiment, the radiation structure 112 comprises a sheet made of a material that is embedded with colorless light diffusing particles such as ACRYLITE™ EndLighten acrylic sheet. The radiation structure 112 also comprises a plurality of radiation sources, in this embodiment infrared (IR) light emitting diodes (LEDs) 122, that are positioned about the periphery of the sheet. The IR radiation emitted by the IR LEDs 122 enters into the sheet and is diffused in a direction normal to its surface, towards the touch panel 102.

A radiation absorbing material 116 such as, for example, black electrical tape is positioned about the periphery of the touch panel 102 with the exception of locations corresponding to the positions of the two imaging devices 114a and 114b so as not to occlude the fields of view of the imaging devices 114a and 114b looking into the touch panel 102. The radiation absorbing material 116 absorbs optical radiation in the touch panel 102 that reaches the edge of the touch panel 102 where the radiation absorbing material 116 is positioned. The radiation absorbing material 116 also prevents ambient light from entering into the touch panel 102, or at least significantly reduces the amount of ambient light entering into the touch panel 102.

Imaging devices 114a and 114b are in communication with a master controller 118 where image data in captured image frames is processed to determine the location of a pointer proximate to the top surface of the first transparent panel 106a of the touch panel 102, hereinafter referred to as the touch surface 115, as will be described in further detail herein. The master controller 118 has its own processing structure for processing the image frames, but in this embodiment is also connected to another processing structure such as general purpose computing device 120 that executes a host application and one or more application programs. Image data generated by the general purpose computing device 120 is displayed on the display unit 104 and, in combination with pointer location data, the image data reflects pointer activity. In this manner, the general purpose computing device 120 and display unit 104 allow pointer contact on the touch surface 115 of the touch panel 102 to be recorded as writing or drawing or to be used to control execution of one or more application programs executed by general purpose computing device 120.

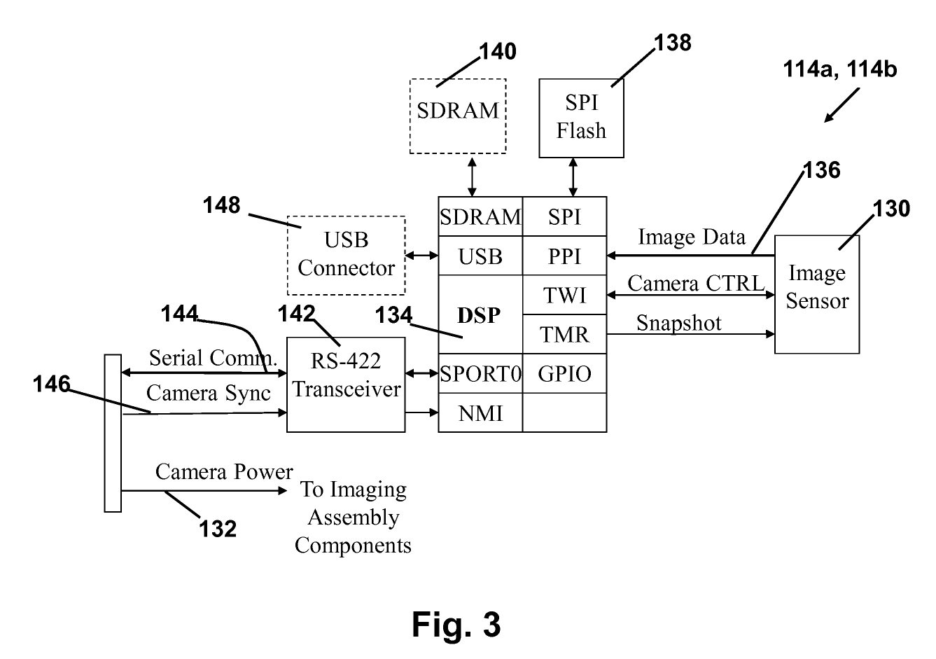

Turning now to FIG. 3, a block diagram of components of each of the imaging devices 114a and 114b is shown. Each imaging device (114a, 114b) comprises an image sensor 130 such as the Aptina (Micron) MT9V034 that has an image capture resolution of 752×480 pixels. The image sensor 130 is fitted with a two element, plastic lens (not shown) that provides the image sensor 130 with a field of view of approximately 104 degrees. Power for the components of the imaging device is provided via power line 132. The image sensor 130 is sensitive to at least infrared radiation.

A digital signal processor (DSP) 134, such as that manufactured by Analog Devices of Norwood, Mass., U.S.A., under part number ADSP-BF522 Blackfin, communicates with the image sensor 130 over an image data bus 136 via a parallel port interface (PPI). A serial peripheral interface (SPI) flash memory 138 is available to the DSP 134 via an SPI port and stores firmware for image assembly operations. Depending on the size of captured image frames as well as the processing requirements of the DSP 134, the imaging device may optionally comprise synchronous dynamic random access memory (SDRAM) 140 to store additional temporary data. SDRAM 140 is shown with dotted lines. The image sensor 130 also communicates with the DSP 134 via a two-wire interface (TWI) and a timer (TMR) interface. The control registers of the image sensor 130 are populated by the DSP 134 via the TWI in order to configure parameters of the image sensor 130, such as the integration period for the image sensor 130.

In this embodiment, the image sensor 130 operates in snapshot mode. In the snapshot mode, the image sensor 130, in response to an external trigger signal received from the DSP 134 via the TMR interface that has a duration set by a timer on the DSP 134, enters an integration period during which an image frame is captured. Following the integration period, after the generation of the trigger signal by the DSP 134 has ended, the image sensor 130 enters a readout period during which time the captured image frame is available. With the image sensor 130 in the readout period, the DSP 134 reads the image frame data acquired by the image sensor 130 over the image data bus 136 via the PPI. The DSP 134 in turn processes image frames received from the image sensor 130 and provides pointer location information to the master controller 118.

The DSP 134 also communicates with an RS-422 transceiver 142 via a serial port (SPORT) and a non-maskable interrupt (NMI) port. The RS-422 transceiver 142 communicates with the master controller 118 over a differential synchronous signal (DSS) communications link 144 and a sync line 146.

DSP 134 may also optionally be connected to a USB connector 148 via a USB port as indicated by dotted lines. The USB connector 148 can be used to connect the imaging device to diagnostic equipment.

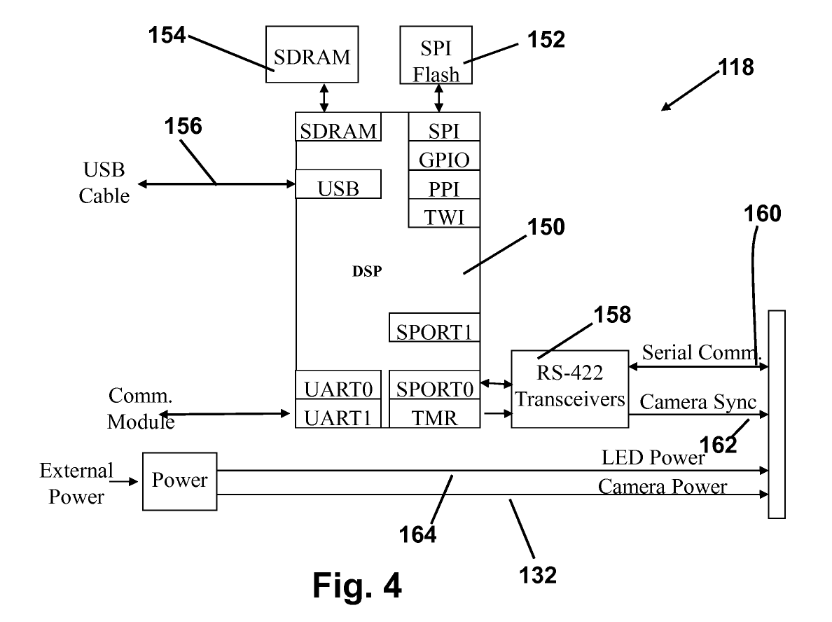

Components of the master controller 118 are illustrated in FIG. 4. As can be seen, master controller 118 comprises a DSP 150 such as that manufactured by Analog Devices under part number ADSP-BF522 Blackfin. A serial peripheral interface (SPI) flash memory 152 is connected to the DSP 150 via an SPI port and stores the firmware used for master controller operation. A synchronous dynamic random access memory (SDRAM) 154 that stores temporary data for system operation is connected to the DSP 150 via an SDRAM port.

In this embodiment, the DSP 150 communicates with the general purpose computing device 120 over a USB cable 156 via a USB port (not shown). Furthermore, the DSP 150 communicates through its serial port (SPORT) with the imaging devices 114a and 114b via an RS-422 transceiver 158 over the differential synchronous signal (DSS) communications link 160. The DSP 150 also communicates with the imaging devices 114a and 114b via the RS-422 transceiver 158 over the camera synch line 162. In some embodiments as will be described, radiation sources, such as IR LEDs, are employed. The radiation sources may be provided with their power via power line 164.

The architectures of the imaging devices 114a and 114b and the master controller 118 are similar. By providing a similar architecture between the imaging devices 114a and 114b and the master controller 118, the same circuit board assembly and common components may be used for both thus reducing the part count and cost of the overall system. Differing components are added to the circuit board assemblies during manufacture dependent upon whether the circuit board assembly is intended for use in the imaging devices 114a and 114b or in the master controller 118. For example, the master controller 118 may require a SDRAM 154 whereas the imaging devices 114a and 114b may not.

The general purpose computing device 120 in this embodiment is a personal computer comprising, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computer may also comprise a network connection to access shared or remote drives, one or more networked computers, or other networked devices.

During operation, IR radiation emitted by the IR LEDs 122 enters into, and is diffused within, the sheet of radiation structure 112 towards the first and second transparent panels 106a and 106b. The IR radiation travels through the transparent panels 106a and 106b towards the touch surface 115 and is emitted out of the touch panel 102 via the touch surface 115. The radiation absorbing material 116 absorbs optical radiation that reaches the edge of the touch panel 102, rather than reflecting it, and also prevents or significantly hinders ambient light from entering into the touch panel 102. Imaging devices 114a and 114b capture image frames of the passage 110 and a portion of each of the first and second transparent panels 106a and 106b.

During operation, in the event a pointer P such as for example a user's finger or a pen tool comes into proximity with the touch surface 115, some of the IR radiation being emitted via the touch surface 115 from the touch panel 102 is reflected off of pointer P back towards the passage 110. In this description, a pointer being brought into proximity with the touch surface 115 is intended to mean that a pointer is being brought into contact with the touch surface 115 or the pointer is hovering just apart from the touch surface 115. The IR radiation escapes from the bottom surface of the first transparent panel 106a where it is captured as image data by the imaging devices 114a and 114b looking into the passage 110, representing an image of the pointer P. The reflected IR radiation continues across the passage 110 and reaches the top surface of the second transparent panel 106b. A portion of the IR radiation is then reflected back towards the passage 110, where it is captured as image data by the imaging devices 114a and 114b representing a reflected image of the pointer P, hereinafter referred to as P′. The image data captured by the imaging devices 114a and 114b is communicated to the master controller 118 for processing, as will be described.

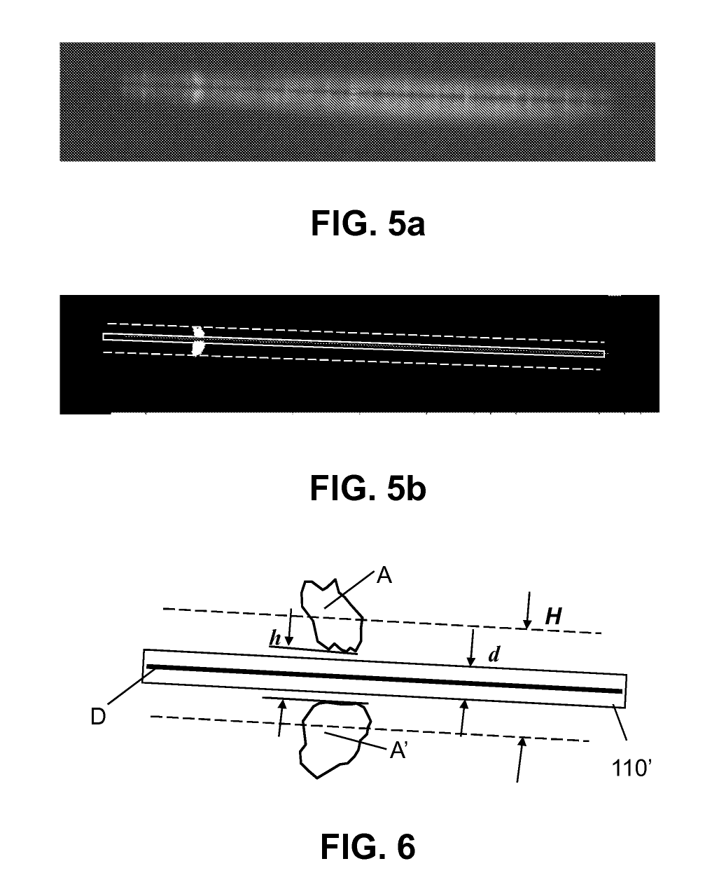

Turning now to FIG. 5a, there is shown an exemplary image frame captured by one of the imaging devices 114a and 114b while a pointer is brought into proximity with the touch surface 115. FIG. 5b shows the image frame of FIG. 5a after processing to remove ambient light. The details of the processing will be discussed below.

For ease of understanding, the image frame of FIG. 5b is schematically illustrated in FIG. 6. As can be seen, when a pointer is brought into proximity with touch surface 115, IR radiation is reflected off of the pointer and back through the first transparent panel 106a towards the passage 110. The IR radiation escapes from the bottom surface of the transparent panel 106a, and thus an object image A corresponding to the pointer appears in the image frame. The IR radiation travels across the passage 110 where it contacts the top surface of the second transparent panel 106b. A portion of the IR radiation is reflected back towards the passage 110, and thus a reflected object image A′ of the pointer appears in the image frame. As will be appreciated, the reflection object image A′ of the pointer is not an exact mirror image of image A, however reflection object image A′ provides enough detail for image processing to determine the contact status of the pointer and, if necessary, to accurately calculate the location of the pointer, as will be described.

As shown in FIG. 6, object image A and reflected object image A′ are separated by a distance represented by reference character h. The dark line D in FIG. 6 that runs approximately midway between object image A and reflected object image A′ corresponds to the middle of the passage 110 as viewed by the imaging devices 114a and 114b. The passage 110 is also identified in the captured images (hereinafter referred to as “passage image 110”), and appears as a dark rectangular shape having a height identified by reference character d. As will be appreciated, the height d of the passage image 110′ is constant for all captured image frames and thus is used as a reference for determining contact status, as will be described. The height d of the passage image 110′ as it appears in the captured image frames is calculated according to a calibration method, as will be described below. A boundary reference identified by reference character H is defined for image processing purposes, and is used as a reference identified in the captured image frames for determining contact status as will be described. The value of boundary H is calculated according to a pinhole camera model. In this embodiment, in the event a pointer comes within 5 mm of the touch surface 115, it is determined to be a touch contact. As will be appreciated, the value of H is dependent on the distance of the pointer to the corresponding imaging device. For example, 5 mm above the touch surface 115 at the furthest corner away from imaging device 114a corresponds to a value of H of approximately 5 pixels in a captured image. 5 mm above the touch surface 115 at a position near the imaging device 114a corresponds to a value of H of approximately 2 pixels in a captured image. The closer the pointer is to the imaging device, the smaller the value of H.

The boundaries d and H are used as references to determine contact status, based on the distance h between object image A and reflected object image A′. Table 1 summarizes the conditions for each characterization of contact status.

TABLE 1
Conditions for Contact Status

| Condition | Contact Status |
|---|---|
| d ≦ h < H | Touch |
| h ≧ H | Non-Touch |

As shown in Table 1, in the event the distance h between object image A and reflected object image A′ is greater than or equal to the height d of the passage image 110′ and less than boundary H, it is determined that the detected contact is in direct contact with the touch surface 115 or close enough to the touch surface 115 to be considered a touch, and thus the contact status is determined to be touch contact. In the event the distance h between object image A and reflected object image A′ is greater than boundary H, it is determined that the detected contact is not close enough to the touch surface 115 to be considered a touch contact, and thus the detected contact is determined to be a non-touch contact.

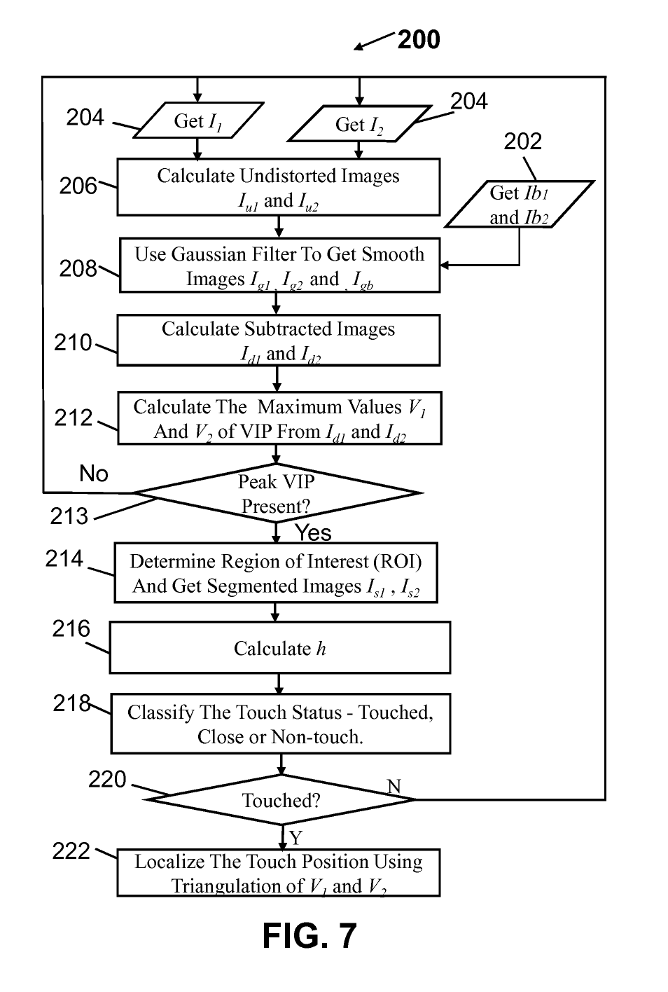

A method 200 for processing the captured image frames to determine the contact status and location of a pointer brought into proximity with the touch surface 115 will now be described with reference to FIG. 7. Method 200 begins when imaging devices 114a and 114b capture background image frames I_{b1} and I_{b2}, respectively, in the event that no pointer is present, and the radiation structure 112 is powered ON (step 202). The background image frames I_{b1} and I_{b2} are used to remove ambient light from image frames captured while a pointer is proximate to the touch surface 115. The method continues when imaging devices 114a and 114b capture image frames I₁ and I₂, respectively (step 204). Image frames I₁ and I₂ are processed to correct for distortions, thereby creating undistorted image frames Lᵤ₁ and Iᵤ₂ (step 206). The undistorted image frames Iᵤ₁ and Iᵤ₂, and background image frames I_{b1} and I_{b2} are smoothed through a Gaussian filter, thereby creating smoothed image frames I_{g1}, I_{g2}, I_{gb1}, and I_{gb2}, respectively (step 208). The smoothed image frames I_{g1} and I_{g2} are further processed to remove ambient light (step 210) according to a method described in U.S. Patent Application Publication No. 2009/0277694 to Hansen, et al., filed on May 9, 2008 entitled “Interactive Input System and Bezel Therefor”, and assigned to the assignee of the subject application, the contents of which are incorporated herein by reference. In general, the smoothed image frames I_{g1} and I_{g2} are processed to remove ambient light by subtracting the background image frames I_{gb1} and I_{gb2}, according to equations (1) and (2):

I_{d1}=I_{g1}−I_{gb1} (1)

I_{d2}=I_{g2}−I_{gb2} (2)

Once the subtracted images I_{d1} and I_{d2} are obtained, the vertical intensity profile (VIP) of each of the subtracted images I_{d1} and I_{d2} is calculated by the DSP 134 of the respective imaging device 114a and 114b, and the peak VIP values V₁ and V₂ are determined (step 212). The VIP is calculated according to a method described in aforementioned U.S. Patent Application Publication No. 2009/0277694 to Hansen, et al., In general, the VIP is calculated by summing the intensity values at each pixel column and then normalizing by dividing the total intensity value of each pixel column by the corresponding number of pixel columns. The peak value of VIP corresponds to the approximate pointer contact location and the approximate reflected pointer location. In the event no that peak VIP values are present, the method returns to step 204 (step 213).

With the approximate pointer contact location having been determined, a region of interest (ROI) is then determined by defining a range near the approximate pointer contact location and the approximate reflected pointer contact location (determined in step 212) and image frames I_{d1} and I_{d2} are segmented as image frames Iₛ₁ and Iₛ₂ so as to “zoom in” on the defined range near the approximate pointer contact location and the approximate reflected pointer location (step 214).

The distance h between the object image A of the pointer and reflected object image A′ of the pointer is then calculated (step 216), and distance h is compared to boundaries d (height of the passage) and H to determine contact status (step 218) according to Table 1 above.

In the event that the contact status is determined to be non-touch, the method returns to step 204 where another set of image frames are captured (step 220). In the event that the contact status is determined to be touch (step 220), the position of the pointer is calculated using triangulation of V₁ and V₂ (step 222).

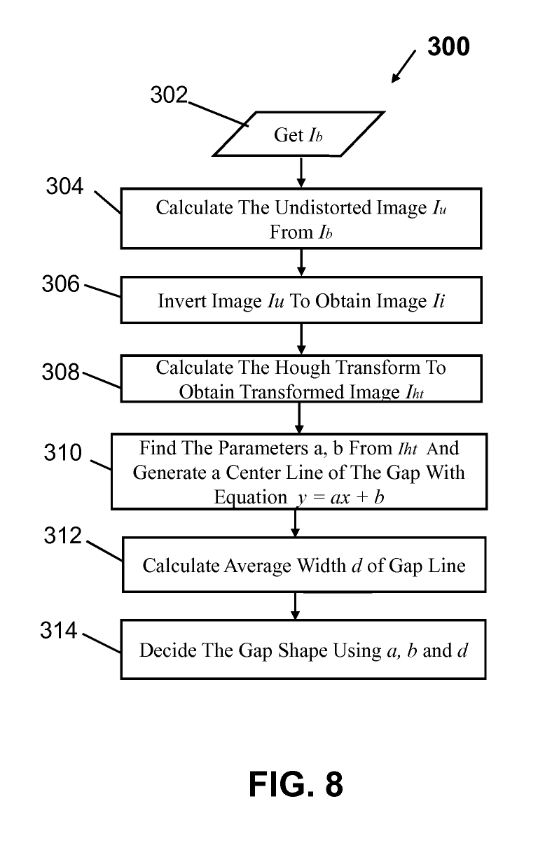

As mentioned previously, the height d of the passage image 110′ is calculated according to a calibration method. Turning now to FIG. 8, a calibration method 300 for calculating the height d of the passage image 110′ is shown. First, a background image frame I_{b} is captured while no pointer is present, and the radiation structure 112 is powered ON (step 302). Background image frame I_{b} is then processed to correct for distortions, thereby creating undistorted image frame I_{ub} (step 304). Image frame I_{ub} is then inverted using known techniques, thereby creating image frame Iᵢ (step 306). The Hough Transform is then applied to image frame Iᵢ to obtain transformed image Iₕₜ (step 308). The parameters a and b for the center line of the passage image 110′ are determined from the transformed image Iₕₜ (step 310), and an equation representing the center line of the passage image 110′ is generated according to equation (3):

y=ax+b (3)

The average width d of the passage image 110′ is then calculated (step 312). In this embodiment, the average width d of the passage image 110′ is calculated using the center line determined above. To calculate the average width d, the center line is moved up one pixel row and a binary pixel overlap value is calculated to determine a pixel overlap value. The pixel overlap value is determined by comparing all binary code values of the pixel row to calculate the percentage of pixels having a binary code value of “1”. The pixel overlap value is compared to a predefined threshold value, such as for example that value that would represent a 50% overlap, and if the pixel overlap value is greater than the threshold value, the center line is moved up to the next pixel row. This method continues until the pixel overlap value is less the threshold value, at which point the pixel row having the pixel overlap value less than the threshold value is considered to not be part of the passage image 110′. As such, the pixel row prior to the pixel row having a pixel overlap value less than the threshold value is determined to be the upper boundary of the passage image 110′. A similar process is used to determine the lower boundary of the passage image 110′, starting with one pixel row below the center line and moving downwards. With the upper and lower boundaries having been determined, the average width d of the passage image is calculated, and the shape of the passage image 110′ is determined using parameters a, b and d (step 314).

An example of using method 200 to determine the location of a pointer will now be described. In this particular example, the pointer is a user's finger. Although image frames captured by only one of the imaging devices will be shown in the following example, it will be appreciated that image frames captured by the other of the imaging devices will be used for processing.

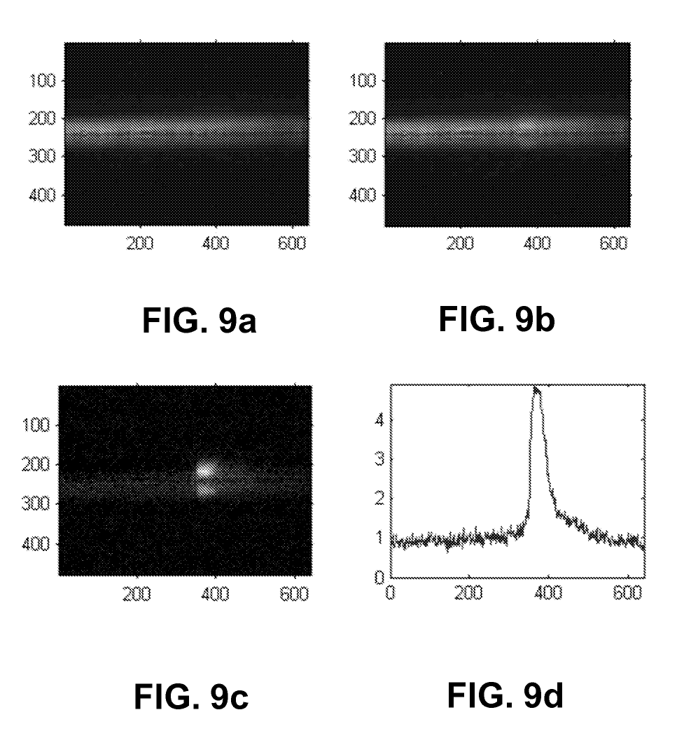

An exemplary background image frame obtained at step 202 is shown in FIG. 9a. An exemplary image frame captured by the imaging device while a pointer is proximate to the touch surface 115, obtained at step 204, is shown in FIG. 9b. The image frames of FIGS. 9a and 9b are smoothed through a Gaussian filter at step 208 (not shown), and ambient light is removed from the smoothed image frame of FIG. 9b by subtracting the smoothed background image frame of FIG. 9a at step 210. The resulting image frame is shown in FIG. 9c. The VIP of FIG. 9c is calculated at step 212 and is shown in FIG. 9d. As can be seen, the VIP has a single peak corresponding to the approximate pointer contact location.

A region of interest (ROI) is determined by defining a range about the approximate pointer contact location, and the image frame of FIG. 9c is then segmented so as to “zoom in” on the defined range near the approximate pointer contact location at step 214 (not shown). The distance h between the object image A of the pointer and reflected object image A′ of the pointer is calculated, and compared to boundaries d (height of the passage) and H (pre-defined boundary) to determine contact status (step 218) according to Table 1 above. Since the distance h is less than boundary H and greater than the height d of the passage, it is determined that the contact status is touch (step 220). The position of the pointer with respect to the touch surface 115 is then calculated at step 222.

Another example of using method 200 to determine the location of a pointer will now be described. In this particular example, the pointer is an active pointer that emits its own IR radiation, such as that described in U.S. patent application Ser. No. 13/075,508 to Popovich, et al., filed on Mar. 30, 2011 entitled “Interactive Input System and Method”, and assigned to the assignee of the subject application, the contents of which are incorporated herein by reference. Although image frames captured by only one of the imaging devices will be shown in the following example, it will be appreciated that image frames captured by the other of the imaging devices are also processed in a similar manner.

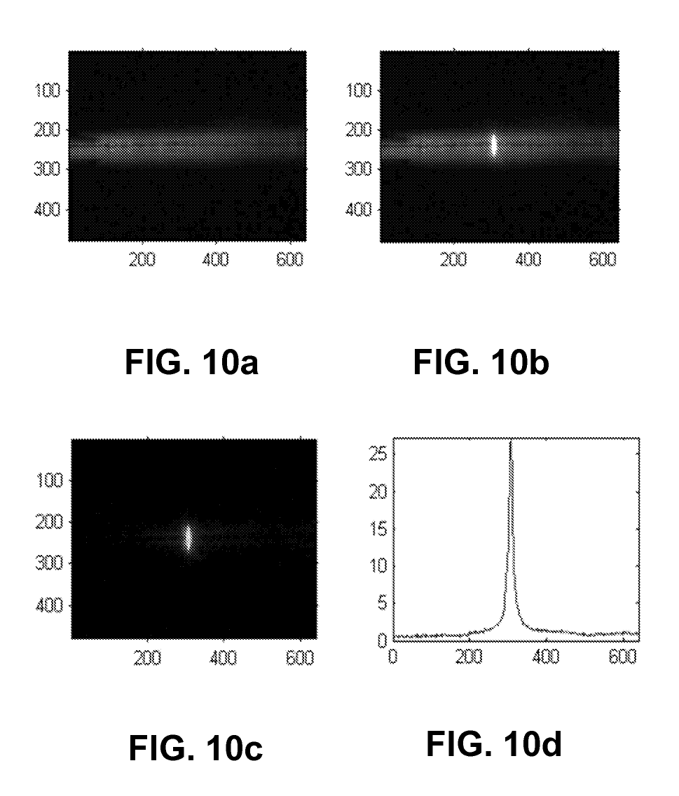

An exemplary background image frame obtained at step 202 is shown in FIG. 10a. An exemplary image frame captured by the imaging device while a pointer is proximate to the touch surface 115 obtained at step 204 is shown in FIG. 10b. As can be seen, in comparison to FIG. 9b, the pointer is more visible in FIG. 10b due to the fact that it is an active pointer and thus is emitting IR radiation and not just reflecting it. The image frames of FIGS. 10a and 10b are smoothed through a Gaussian filter at step 208 (not shown), and ambient light is removed from the smoothed image frame of FIG. 10b by subtracting the smoothed background image frame of FIG. 10a at step 210. The resulting image frame is shown in FIG. 10c. The VIP of FIG. 10c is calculated at step 212 and is shown in FIG. 10d. As can be seen, the VIP has a single peak corresponding to the approximate pointer contact location.

A region of interest (ROI) is determined by defining a range near the approximate pointer contact location, and the image frame of FIG. 10c is segmented so as to “zoom in” on the defined range near the approximate pointer contact location at step 214 (not shown). The distance h between the object image A of the pointer and reflected object image A′ of the pointer is calculated, and distance h is then compared to boundaries d (height of the passage) and H to determine contact status (step 218) according to Table 1 above. Ideally, when the distance h is less than boundary H and greater than the height d of the passage, it is determined that the contact status is touch (step 220). However, in this embodiment, because the pointer is an active pointer that emits IR radiation, the pointer image and the reflected image are saturated. In order to avoid the saturation, the exposure time of the imaging device is reduced so that the pointer image and its reflected image are not saturated. Then the contact status can be determined according to Table 1 described above. If the exposure time of the imaging device is not adjusted and the saturated images are being processed, the contact status can be determined according to Table 4, the details of which are discussed below. The position of the pointer with respect to the touch surface 115 is then calculated at step 222.

Another example of using method 200 to determine the location of a pointer will now be described. In this particular example, there are multiple pointers due to a user having brought three fingers of their hand into proximity with the touch surface 115. Although image frames captured by only one of the imaging devices will be shown in the following example, it will be appreciated that image frames captured by the other of the imaging devices will be used for processing.

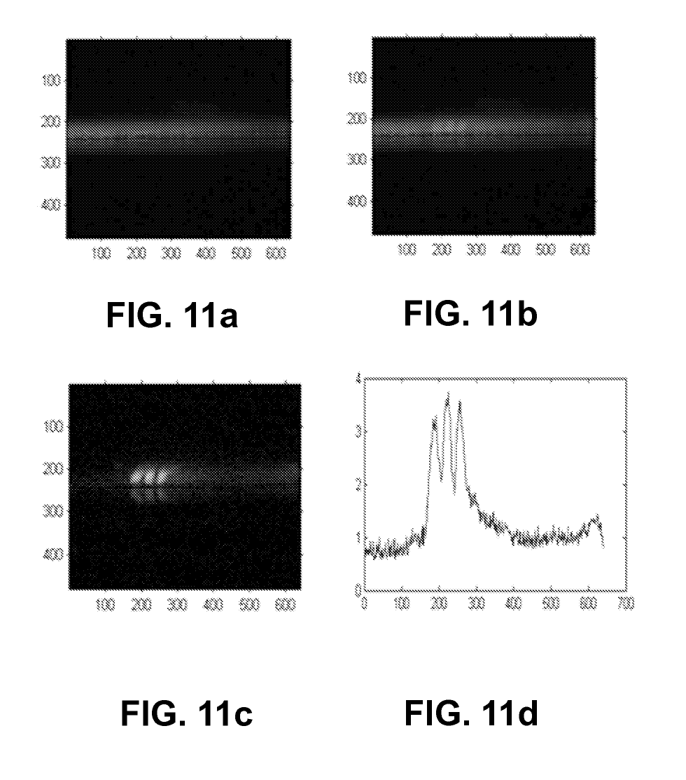

An exemplary background image frame obtained at step 202 is shown in FIG. 11a. An exemplary image frame captured by the imaging device in the event a pointer is brought into proximity with the touch surface 115 obtained at step 204 is shown in FIG. 11b. The image frames of FIGS. 11a and 11b are smoothed through a Gaussian filter at step 208 (not shown), and ambient light is removed from the smoothed image frame of FIG. 11b by subtracting the smoothed background image frame of FIG. 11a at step 210. The resulting image frame is shown in FIG. 11c. The VIP of FIG. 11c is calculated at step 212 and is shown in FIG. 11d. As can be seen, the VIP has three peaks corresponding to the approximate pointer contact locations of the three finger tips.

A region of interest (ROI) is determined by defining a range near the approximate pointer contact locations and the image frame of FIG. 11c is segmented so as to “zoom in” on the defined range near the approximate pointer contact location at step 214 (not shown). The distance h between the object image A of the pointers and reflected object image A′ of the pointers is calculated, and distance h is then compared to boundaries d (height of the passage) and H (pre-defined boundary) to determine contact status (step 218) according to Table 1 above. Since the distance h is less than boundary H and greater than the height d of the passage, it is determined that the contact status is touch (step 220). The position of the pointers with respect to the touch surface 115 is then calculated at step 222.

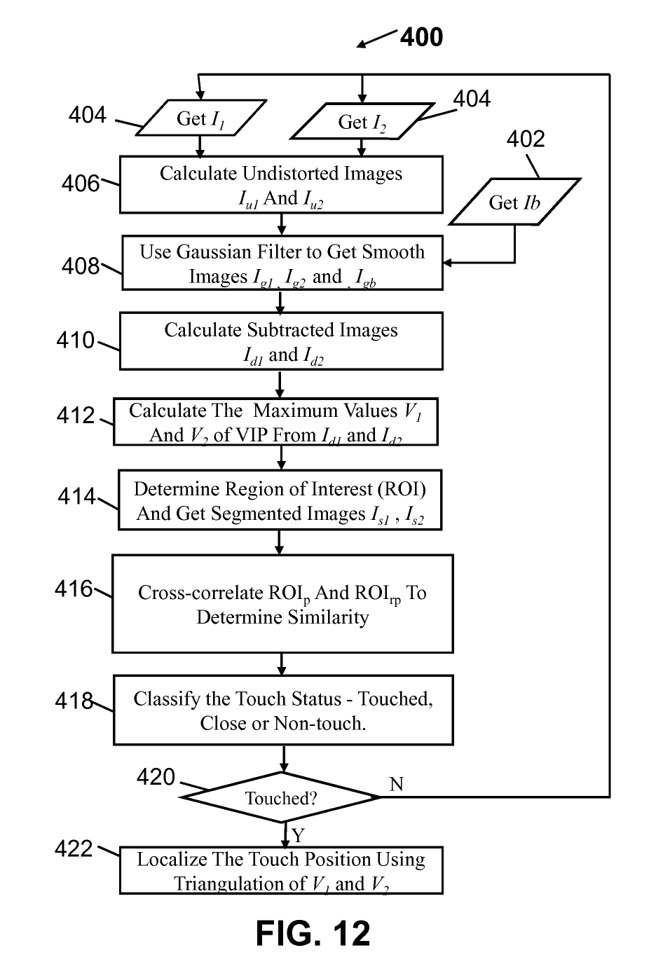

Although it is described above, with reference to Table 1, that contact status is determined by comparing the distance h between object image A and reflected object image A′ to boundaries d and H, contact status may be determined based on other criteria. For example, contact status may be determined based on the similarity of object image A and reflected object image A′. In this embodiment, a method 400 is used to process the captured image frames to determine the contact status and location of a pointer brought into proximity with the touch surface 115, as will now be described with reference to FIG. 12. As can be seen, method 400 is similar to method 200, with the exception of step 416. At step 416, the ROI of the pointer (ROIₚ) and the ROI of the reflected pointer (ROIᵣₚ) (determined at step 414) are compared using a cross-correlation function, and the contact status is determined based on the similarity of ROIₚ and ROIᵣₚ. The details of the cross-correlation function are well known and are described in Intel® Integrated Performance Primitives for Intel® Architecture, Reference Manual, Volume 2: Image and Video Processing, September 2007, page 11-89. In this embodiment, the cross-correlation threshold for similarity is defined as 70%. Those skilled in the art will appreciate that the threshold for similarity may be adjusted to a different value such as for example 65%, 75%, 80% or 85%, depending on the desired accuracy of the interactive input system. Table 2 summarizes the conditions for each characterization of contact status.

TABLE 2
Conditions for Contact Status based on Cross-Correlation

| Condition | Contact Status |
|---|---|
| Cross-Correlation ≧ 70% | Touch |
| Cross-Correlation < 70% | Non-Touch |

As will be appreciated, the closer the pointer gets to the touch surface 115, the more similar the ROIₚ of the pointer and the ROIᵣₚ of the reflected pointer are to one another. In the event that the pointer contacts the touch surface 115, the similarity between ROIₚ and ROIᵣₚ reaches a maximum value, and thus the contact status is determined to be direct touch. Method 400 then continues to step 420, which is similar to step 220 of method 200.

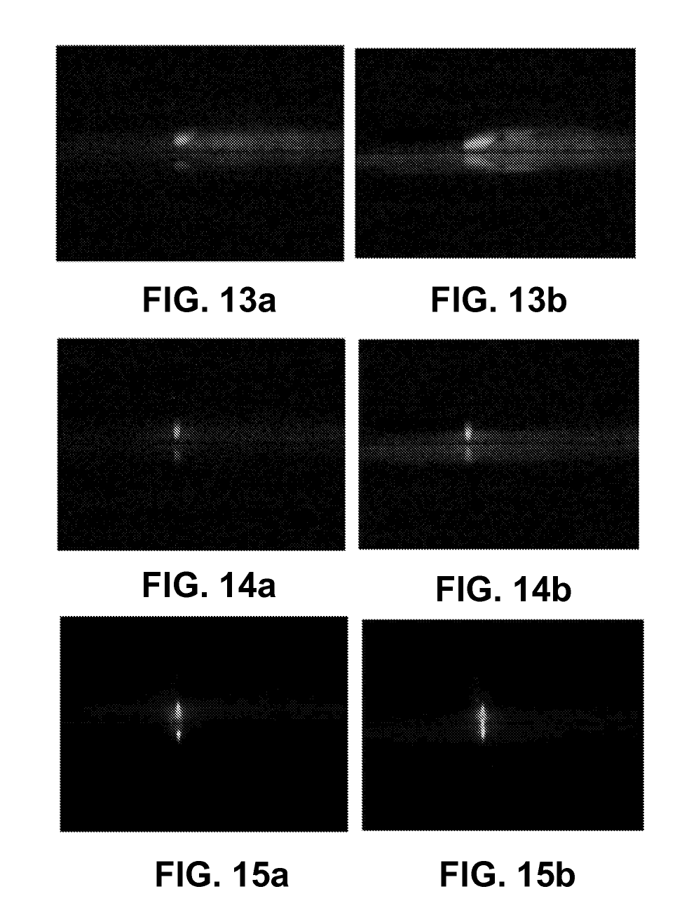

FIG. 13a shows an exemplary image frame in the event a pointer in the form of a finger is brought into proximity with the touch surface 115, wherein the contact status is non-touch. For illustrative purposes, the region of interest ROIₚ of the pointer and the region of interest ROIᵣₚ of the reflected pointer are identified. FIG. 13b shows an exemplary image frame in the event a pointer in the form of a finger is brought into proximity with the touch surface 115, wherein the contact status is touch. Again, for illustrative purposes, the region of interest ROIₚ of the pointer and the region of interest ROIᵣₚ of the reflected pointer are identified. Comparing FIGS. 13a and 13b, it can be seen that the ROIₚ and the ROIᵣₚ of FIG. 13b are a lot more similar to one another than the ROIₚ and the ROIᵣₚ of FIG. 13a.

FIG. 14a shows an exemplary image frame in the event a pointer in the form of a passive pen is brought into proximity with the touch surface 115, wherein the contact status is non-touch. For illustrative purposes, the region of interest ROIₚ of the pointer and the region of interest ROIᵣₚ of the reflected pointer are identified. FIG. 15b shows an exemplary image frame captured while a pointer in the form of a passive pen is proximate to the touch surface 115, wherein the contact status is touch. Again, for illustrative purposes, the region of interest ROIₚ of the pointer and the region of interest ROIᵣₚ of the reflected pointer are identified. Comparing FIGS. 14a and 14b, it can be seen that the ROIₚ and the ROIᵣₚ of FIG. 14b are a lot more similar to one another than the ROIₚ and the ROIᵣₚ of FIG. 14a.

FIG. 15a shows an exemplary image frame in the event a pointer in the form of an active pen is brought into proximity with the touch surface 115, wherein the contact status is non-touch. For illustrative purposes, the region of interest ROIₚ of the pointer and the region of interest ROIᵣₚ of the reflected pointer are identified. FIG. 15b shows an exemplary image frame in the event a pointer in the form of an active pen is brought into proximity with the touch surface 115, wherein the contact status is touch. Again, for illustrative purposes, the region of interest ROIₚ of the pointer and the region of interest ROIᵣₚ of the reflected pointer are identified. Comparing FIGS. 15a and 15b, it can be seen that the ROIₚ and the ROIᵣₚ of FIG. 15b are a lot more similar to one another than the ROIₚ and the ROIᵣₚ of FIG. 15a.

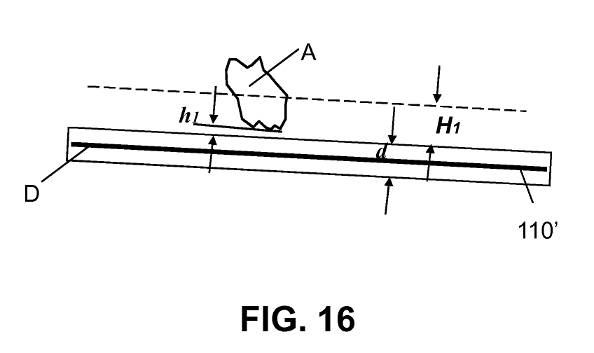

In another embodiment, touch status may be calculated using only the region of interest ROIₚ of the pointer, as shown in FIG. 16. In this embodiment, the distance from object image A to the top of the passage image 110′ is calculated and identified by reference character h₁. The dark line D indicates the middle of the passage image 110′ as viewed by the imaging devices 114a and 114b. Similar to above, the height of the passage image 110′ is identified by reference character d. A boundary reference identified by reference character H₁ is defined for image processing purposes, and is used as a reference for determining contact status. Similar to boundary H described above, the value of boundary H₁ is calculated according to a pinhole camera model.

The boundaries d and H₁ are used as references to determine contact status, based on the distance h₁ between object image A and the top of the passage image 110′ as it appears in the captured image frames. Table 3 summarizes the conditions for each characterization of contact status.

TABLE 3
Conditions for Contact Status

| Condition | Contact Status |
|---|---|
| d/2 ≦ h₁ < H₁ | Touch |
| h ≧ H₁ | Non-Touch |

As shown in Table 3, in the event the distance h₁ between object image A and the top of the passage image 110′ is greater than or equal to half of the height d of the passage (d/2) and less than boundary H₁, it is determined that the detected contact is in direct contact with the touch surface 115 or close enough to the touch surface 115 to be considered a touch, and thus the contact status is determined to be a touch contact. In the event the distance h between object image A and the top of passage image 110′ is greater than boundary H₁, it is determined that the detected contact is not close enough to the touch surface 115 to be considered a touch contact, and thus the detected contact is determined to be a non-touch contact.

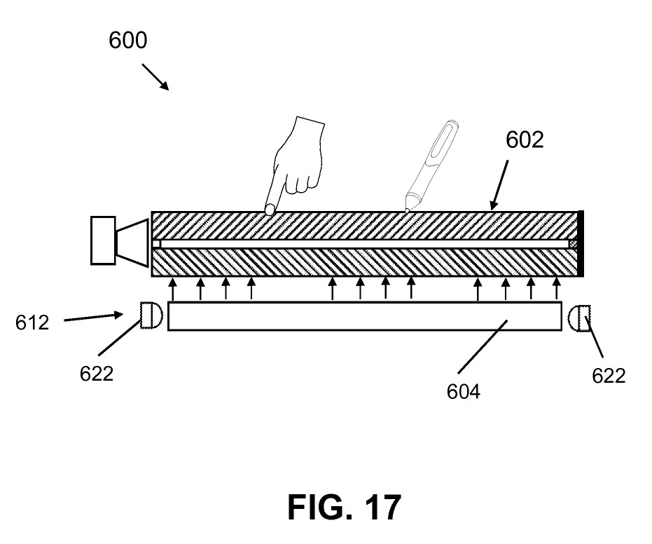

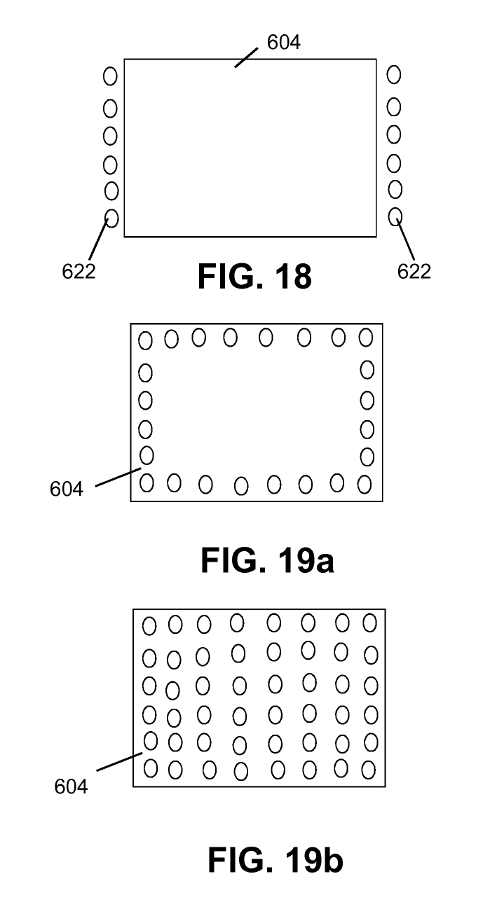

Turning now to FIGS. 17 and 18, another embodiment of an interactive input system is shown and is generally identified by reference numeral 600. Interactive input system 600 is similar to interactive input system 100, with the exception of radiation structure 612. In this embodiment, the radiation structure 612 comprises a plurality of IR LEDs 622 integrated with a display panel 604. The IR LEDs 622 are positioned along two sides of the display panel 604 and are configured to emit IR radiation into the display panel 604. The display panel 604 has a diffusing layer (not shown) that directs incoming IR radiation normal to the surface of the display panel 604. The redirected IR radiation travels through the display panel 604 towards the touch panel 602.

Although the IR LEDs are described as being positioned along two sides of the display panel 604, it will be appreciated that other configurations of IR LEDs 622 may be employed. For example, the IR LEDs may be arranged about the periphery of the display panel 604 or under bottom of the display panel 604. FIG. 19a shows an example wherein the IR LEDs are positioned about the periphery of a bottom surface of the display panel 604. Alternatively, as shown in FIG. 19b, the IR LEDs 622 may be spaced across a bottom surface of the display panel 604.

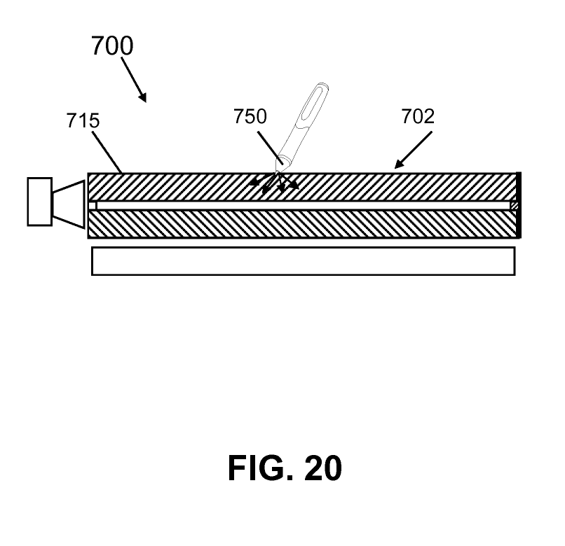

Turning now to FIG. 20, another embodiment of an interactive input system is shown and is generally identified by reference numeral 700. Interactive input system 700 is similar to interactive input system 100; however interactive input system 700 does not include a radiation structure positioned below the touch panel 702. In this embodiment, IR radiation is provided by using an active pen tool 750 such as that described in above incorporated U.S. patent application Ser. No. 13/075,508 to Popovich, et al. Active pen tool 750 is employed and has its own radiation structure to emit IR radiation into the touch panel 702 when the active pen tool 750 contacts the touch surface 715. Image frames captured by the imaging devices associated with interactive input system 700 are processed similar to the method 200 described above. As will be appreciated, the interactive input system 700 operates similar to interactive input system 100 described above, however in the event the active pen tool 750 emits IR radiation into the touch panel 702, the IR radiation causes a saturation between the image of the pen tool 750 and the passage image 110′. As such, Table 1 (above) can be simplified, as shown in Table 4 below:

TABLE 4
Conditions for Contact Status in the event
the pointer is an active pen tool

| Condition | Contact Status |
|---|---|
| h < H | Touch |
| h ≧ H | Non-Touch |

Due to the saturation between the image of the pen tool 750 and the passage image 110′, the contact status of the pointer P is considered a touch if the distance h between an image of the pen tool 750 is less than boundary H. Similar to Table 1, in the event the distance h between object image A and reflected object image A′ is greater than boundary H, it is determined that the detected contact is not close enough to the touch surface 115 to be considered a touch contact, and thus the detected contact is determined to be a non-touch contact.

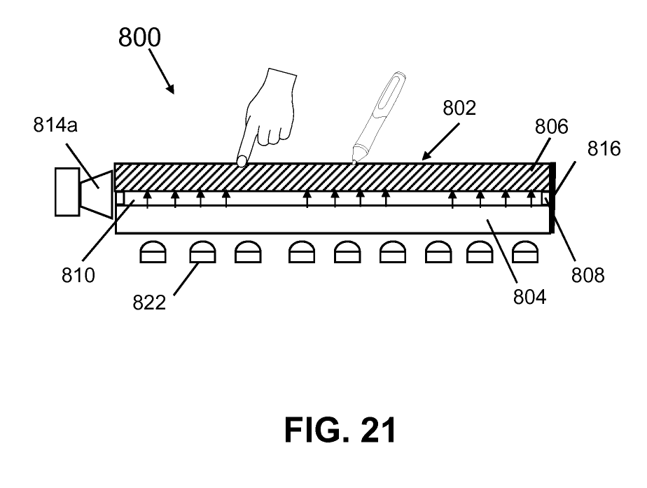

Turning now to FIG. 21, another embodiment of an interactive input system is shown and is generally identified by reference numeral 800. Interactive input system 800 is similar to interactive input system 600 however the touch panel 802 only comprises a single transparent panel 806. The transparent panel 806 is separated from the top surface of the display panel 804 by a spacer 808 in a parallel-spaced relationship defining a passage 810 between the bottom planar surface of the transparent panel 806 and the top surface of the display panel 804. In this embodiment, the imaging devices 814a (shown) and 814b (not shown) have fields of view looking generally into the passage 810 and a portion of the transparent panel 806 and the top surface of the display panel 804. Similar to that described above, a radiation absorbing material 816 is positioned about the periphery of the touch panel 802 with the exception of locations corresponding to the positions of the two imaging devices 814a and 814b so as not to occlude the fields of view of the imaging devices 814a and 814b looking into the passage 810. As the display panel 804 has a top surface made of a transparent material such as for example glass, the properties of the top surface of the display panel 804 permit interactive input system 800 to monitor pointer activity made on the touch surface 815 similar to that described above. The radiation structure 812 comprises a plurality of IR LEDs 822 integrated with the display panel 804. The IR LEDs 822 are positioned along two sides of a bottom surface of the display panel 804 and are configured to emit IR radiation through the display panel 804 into the touch panel assembly 802.

In another embodiment, the IR LEDs 822 may be positioned along the bottom surface of the display panel 804 in a variety of configurations, such as those shown in FIGS. 19a and 19b described above.

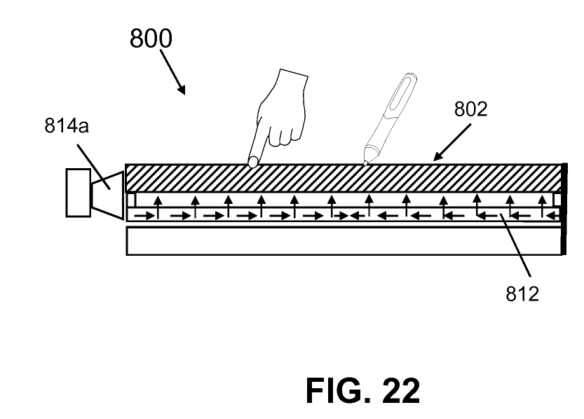

In another embodiment, the radiation structure 812 may be similar to that described above with reference to FIG. 1, wherein the radiation structure 812 includes a sheet made of a material that is embedded with colorless light diffusing particles such as ACRYLITE™ EndLighten acrylic sheet. In this embodiment, as shown in FIG. 22, the radiation structure 812 also comprises a plurality of infrared (IR) light emitting diodes (LEDs) positioned about the periphery of the sheet (not shown). The IR radiation emitted by the IR LEDs is diffused normal to the large surface of the sheet of the radiation structure 812, towards the touch panel 802.

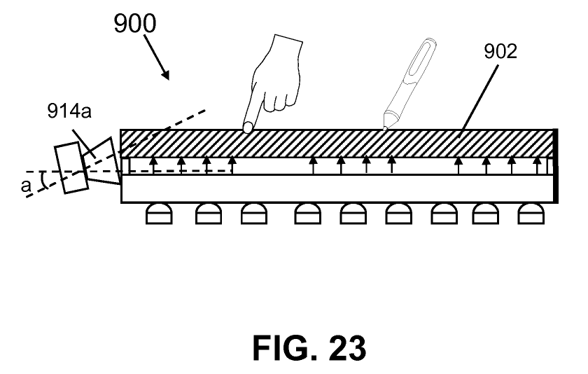

Turning now to FIG. 23, yet another embodiment of an interactive input system is shown and is generally identified by reference numeral 900. Interactive input system 900 is similar to interactive input system 800 however the imaging devices 914a (shown) and 914b (not shown) are adjusted such that the optical axis of each imaging device 914a (shown) and 914b (not shown) is at a non-zero angle a relative to the surface of the touch panel 902. In this embodiment, the optical axis of the imaging device 914a is positioned at an approximate 10 degree angle a relative to the surface of the touch panel 902. Positioning the optical axis of each imaging device to be at a non-zero angle a relative to the surface of the touch panel 902 creates a wider effective touch area which, as will be appreciated, is limited by the field of view of the imaging device.

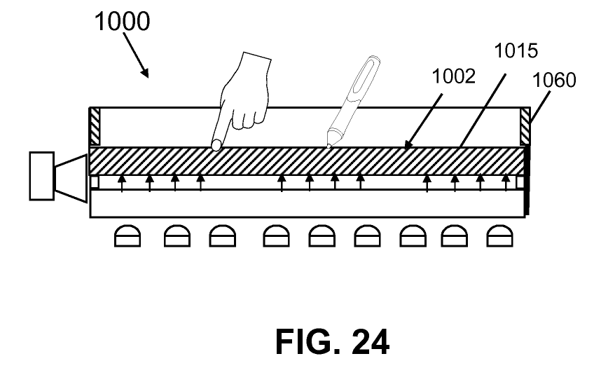

Turning now to FIG. 24, another embodiment of an interactive input system is shown and is generally identified by reference numeral 1000. Interactive input system 1000 is similar to interactive input system 800, with the addition of a light-blocking frame 1060 extending normal to the surface of the touch panel 1002 and extending about the periphery thereof. As will be appreciated, the light-blocking frame is made of a light absorbing material such as for example a black colored plastic and blocks ambient light from entering the touch surface 1015.

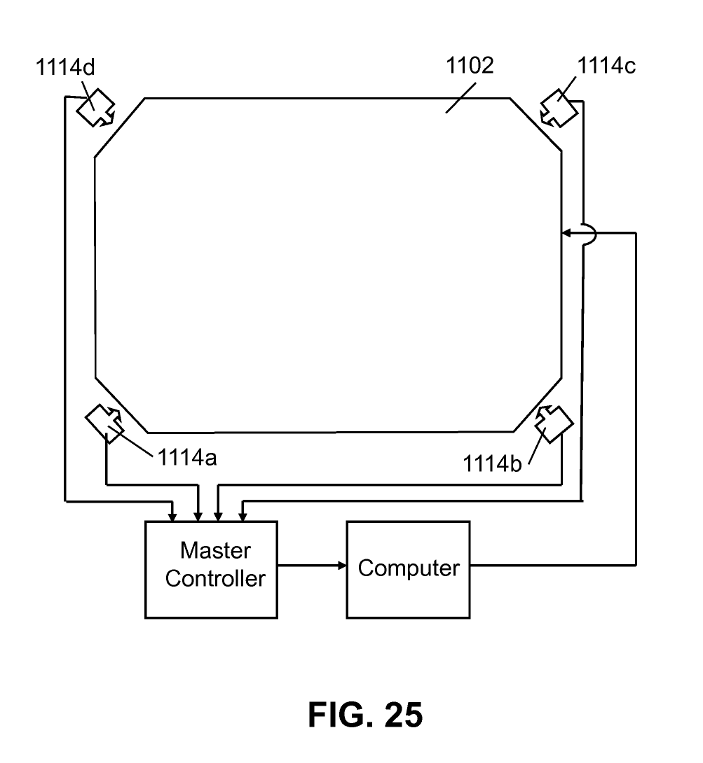

FIG. 25 shows another alternative embodiment of an interactive input system that is capable of detecting the location of multiple touch points on a touch surface. In this embodiment, four (4) imaging devices 1114a to 1114d are positioned adjacent to the touch panel 1102. Each of the imaging devices 1114a to 1114d is positioned adjacent to one corner of the touch panel 1102. As will be appreciated, the coordinates of multiple pointers in touch contact with the display surface can be calculated based on the principles described above.

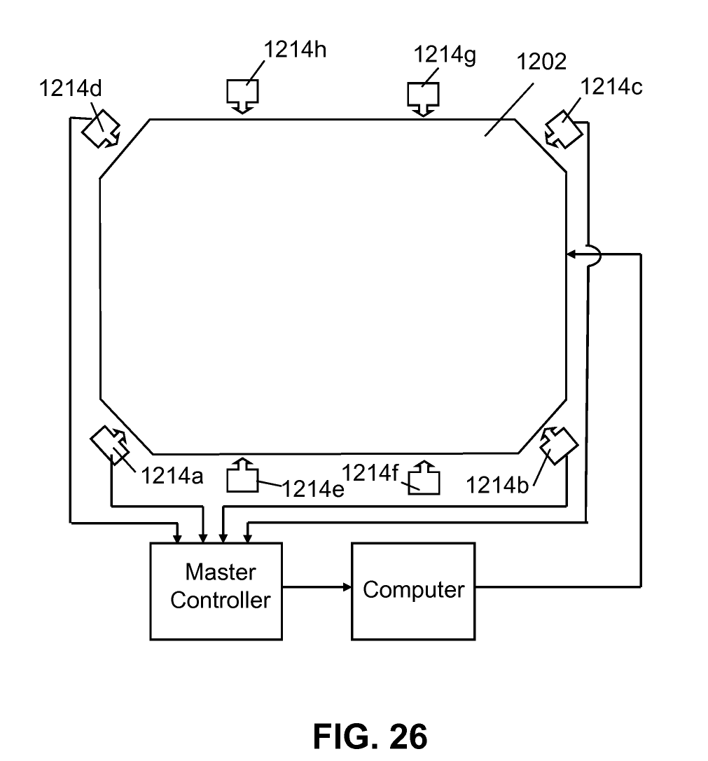

FIG. 26 shows another alternative embodiment of an interactive input system that is capable of detecting the location of multiple touch points on a touch surface. In this embodiment, eight (8) imaging devices 1214a to 1214h are positioned adjacent to the touch panel 1202. Each of the imaging devices 1214a to 1214d are positioned adjacent to a respective corner of the touch panel 1202, imaging devices 1214e and 1214f are positioned along one side of the touch panel 1202, and imaging devices 1214h and 1214g are positioned along another side of the touch panel 1202, opposite imaging devices 1214e and 1214f. The coordinates of multiple pointers in touch contact with the display surface can be calculated according to a method described in U.S. patent application Ser. No. 12/501,088 to Chtchetinine, et al., filed on Jul. 10, 2009 entitled “Interactive Input System”, assigned to the assignee of the subject application, the contents of which are incorporated herein by reference.

Although the transparent panels are described as being made of glass, those skilled in the art that other materials may be used such as for example acrylic.

Although embodiments are described wherein the corners of the transparent panels are configured to accommodate the imaging devices by cutting off the corners of the rectangular shaped panel, those skilled in the art will appreciate that other configurations may be used. For example, the corners may be cut conically.

Although the display panel is described above as being a LCD panel, those skilled in the art will appreciate that the interactive input systems described herein may be coupled to, or integrated with, other types of display panels, as the case may be. For example, display panels such as a laptop screen, a wall-mount display or a table may be used.

Although the cross-correlation threshold is described above as being set to 70%, those skilled in the art will appreciate that the cross-correlation threshold may be adjusted according to the image quality and requirements of the system. For example, should a rougher or finer indication of touch be required.

Although embodiments have been described with reference to the drawings, those of skill in the art will appreciate that variations and modifications may be made without departing from the spirit and scope thereof as defined by the appended claims.

What is claimed is:

1. An interactive input system comprising:
a pair of transparent panels separated in a parallel-spaced relationship defining a passage therebetween;
a radiation structure directing radiation towards the pair of transparent panels, a first portion of the radiation redirected towards the passage in response to at least one pointer brought into proximity with a surface of one of the transparent panels, and a second portion of the first portion of radiation reflected by the other of the transparent panels back towards the passage;
at least two imaging devices positioned adjacent to the pair of transparent panels, each of the at least two imaging devices having a field of view looking into the passage and capturing image frames thereof, the at least two imaging devices capturing the image frames from different vantages; and
processing structure for processing the image frames to determine a location of the at least one pointer.

2. The interactive input system of claim 1 wherein the radiation structure is positioned below the other of the transparent panels.

3. The interactive input system of claim 2 wherein the radiation structure comprises a plurality of light emitting diodes (LEDs) positioned about the perimeter of a diffuser, the diffuser redirecting the light emitting from the LEDs towards the pair of transparent panels.

4. The interactive input system of claim 3 wherein the diffuser is an acrylic sheet and is integrated with the plurality of LEDs.

5. The interactive input system of claim 4 wherein the radiation structure is integrated with the pair of the transparent panels.

6. The interactive input system of claim 5 wherein the LEDs are infrared LEDs.

7. The interactive input system of claim 6 further comprising a display panel positioned below the diffuser.

8. The interactive input system of claim 1 further comprising a display panel positioned below the other of the transparent panels.

9. The interactive input system of claim 8 wherein the radiation structure comprises a plurality of infrared light emitting diodes (LEDs).

10. The interactive input system of claim 9 wherein the LEDs are positioned about the perimeter of the display panel.

11. The interactive input system of claim 9 wherein the LEDs are positioned below the display panel and directing radiation therethrough.

12. The interactive input system of claim 1 wherein the radiation structure is integral with the at least one pointer.

13. The interactive input system of claim 12, wherein the at least one pointer is triggered to cause the radiation structure to direct radiation towards the transparent panels in response to touch contact on the surface.

14. The interactive input system of claim 1 wherein the pair of transparent panels are made of glass or acrylic.

15. The interactive input system of claim 1 wherein the pair of transparent panels are generally rectangular in shape.

16. The interactive input system of claim 15 wherein the at least two imaging devices are positioned adjacent to at least two respective corners of the pair of transparent panels, the at least two corners of the transparent panels configured to accommodate the at least two imaging devices.

17. The interactive input system of claim 1 further comprising a radiation absorbing material disposed about the periphery of the pair of transparent panels with the exception of locations corresponding to the positions of the at least two imaging devices such that the radiation absorbing material does not occlude the field of view of the at least two imaging devices.

18. The interactive input system of claim 1 wherein the at least two imaging devices are positioned such that their optical axis is at an angle with respect to the surface of the one of the transparent panels.

19. The interactive input system of claim 1 comprising a light-blocking frame extending about the periphery of the surface of the one of the transparent panels and extending normal to the surface thereof.

20. The interactive input system of claim 1 wherein the pair of transparent panels and the at least two imaging devices are formed as a single unit.

21. The interactive input system of claim 20 wherein the single unit is positioned atop a display panel.

22. The interactive input system of claim 21 wherein the display panel is an LCD panel.

23. The interactive input system of claim 1 wherein one of the transparent panels is a top surface of a display panel.

24. The interactive input system of claim 23 wherein the display panel is an LCD panel.

25. The interactive input system of claim 1, wherein one of the transparent panels is a display panel.

26. A method comprising:
providing a pair of parallel-spaced transparent panels having a passage defined therebetween;
capturing image frames of at least one pointer brought into proximity with a first surface of one of the transparent panels, the at least one pointer causing radiation to be directed towards the passage from the first surface, at least a portion of the directed radiation reflected by the other of the transparent panels back towards the passage; and
processing the image frames to determine a location of the at least one pointer.

27. The method of claim 26 further comprising:
processing the image frames to identify a pointer image and a reflection of the pointer image.

28. The method of claim 27 further comprising:
calculating a distance between the pointer image and the reflection of the pointer image.

29. The method of claim 28 further comprising:
comparing the distance between the pointer image and the reflection of the pointer image to a predefined threshold distance to determine if the pointer corresponds to one of a touch contact and a non-touch contact.

30. The method of claim 29 wherein in the event the distance between the pointer image and the reflection of the pointer image is greater than the predefined threshold, the pointer corresponds to a non-touch contact.

31. The method of claim 29 wherein in the event the distance between the pointer image and the reflection of the pointer image is less than the predefined threshold, the pointer corresponds to a touch contact.

32. The method of claim 27 further comprising:
comparing the similarity of the pointer image and the reflection of the pointer image to determine contact status based on a predefined similarity threshold.

33. The method of claim 32 wherein the comparing comprises cross-correlating a region of interest associated with the pointer image and a region of interest associated with the reflection of the pointer image.

34. The method of claim 33 wherein in the event the similarity between the pointer image and the reflection of the pointer image is greater than the predefined similarity threshold, the pointer image and the reflection of the pointer image are considered to be similar and the pointer corresponds to a touch contact.

35. The method of claim 33 wherein in the event the similarity between the pointer image and the reflection of the pointer image is less than the predefined similarity threshold, the pointer and the reflection of the pointer are considered not to be similar and the pointer corresponds to a non-touch contact.
